(19) United States
(12) Patent Application Publication
(10) Pub. No.: US 2006/0101685 A1
(43) Pub. Date: May 18, 2006

(54) Substrate with light display

(76) Inventors: Carl Smith III, Osprey, FL (US); Eric Morin, Broomfield, CO (US); Richard Craig Hall, Sarasota, FL (US)

Correspondence Address: HOLLAND & HART, LLP, P.O BOX 8749, DENVER, CO, 80201, US

(21) Appl. No.: 11/219,164

(22) Filed: Sep. 2, 2005

Related U.S. Application Data
(60) Provisional application No. 60/608,783, filed on Sep. 10, 2004.
(60) Provisional application No. 60/617,263, filed on Oct. 8, 2004.

(51) Int. Cl. G09F 13/00

(52) U.S. Cl. 40/556

(57) ABSTRACT

A display with light elements comprises a substrate layer and a display layer. The substrate layer comprises a power source, a plurality of light elements interconnected to the power source, and a controller interconnected to the power source and light elements. The substrate layer may be formed of flexible material. The controller is operable to activate at least a first light element to a different illumination state relative to at least a second light element. The display layer is interconnected to the substrate, covers at least a substantial portion of the substrate, said contains text and/or graphics covering at least a substantial portion thereof. The display layer may be formed of flexible material. At least one of the light sources is visible through the display layer when the light source is activated. The power source may include a solar cell and/or a battery. In embodiments in which the power source comprises both a battery and solar cell, the solar cell may be used to recharge the battery to operate the light elements and controller in low light conditions.

### CROSS-REFERENCE TO RELATED APPLICATIONS

This application claims the benefit of U.S. provisional patent application Ser. No. 60/608,783 filed on Sep. 10, 2004 entitled “BUMPER STICKER WITH LIGHT DISPLAY” and to U.S. Provisional Patent Application Ser. No. 60/617,263 filed on Oct. 8, 2004 entitled “POSTER WITH REMOTELY PROGRAMMABLE DISPLAY, the entire disclosures of which are enclosed herein by reference in their entirety.

### FIELD OF THE INVENTION

The present invention is directed to display devices, and in particular, to displays devices that include at least one light element.

### BACKGROUND OF THE INVENTION

Displays are used in numerous applications, and take numerous different forms, and serve the purpose of conveying a message to a viewer or onlooker. Such a message may be an advertisement, information, or any other particular message desired to be conveyed. For example, retail establishments such as grocery stores and convenience stores generally use numerous different types of displays both for advertising and for conveying information. The displays may be shelf tags indicating a product and a price, floor displays, window displays, and numerous others. Similarly, posters may be used as displays for numerous types of establishments, including retail establishments, theaters, food service establishments, and many public or governmental displays to convey various types of information. Furthermore, numerous different types of vehicle-mounted displays exist, such as bumper stickers, window stickers, and others. Other types of vehicle-mounted displays include advertising displays mounted on the interior and/or exterior portions of vehicles, including taxi vehicles and public transit vehicles such as buses and trains. Displays may also be fixed to benches, buildings, street or lampposts, and hanging banners, to name but a few examples.

Generally, such displays are static displays that are printed in a fixed manner. For example, a poster may have a printed display portion including text and/or graphics for use in an advertising promotion. These displays are often intended for use only during a limited time period, and thus it is desirable to keep the cost of such displays as low as possible. Such displays are generally shipped in tubes with the poster or other display rolled up, which may then be unrolled and mounted an appropriate display mounting device, such as a frame, and displayed in the appropriate location. Such displays generally do not have any lights or other visual elements therein that change the nature of the display. The same is true for most vehicle displays, with a bumper sticker, or advertisement on a public transit vehicle, having a static and fixed printed display.

Other types of displays, however, are lighted displays with dynamic changing display elements. Such displays include moving banners, neon lights, and video displays, to name a few. Such displays are traditionally plugged into a power source to provide the necessary electrical power to operate the display. As such, these lighted displays have relatively high power requirements and are relatively expensive. Furthermore, such displays are also relatively expensive to ship and install as compared to a comparable fixed or static display. Additionally, the location of such displays is generally limited to a location that is in relatively close proximity to a power source. However, such displays are quite popular and have a large market due to the dynamic nature of the display that provides for a visual stimulus to onlookers thus drawing their attention, and often making a more effective display. Furthermore, such displays may be visible in low light conditions further enhancing the viewing ability at night or in other low light situations. Many other displays are simply lighted with a front light or a back light that simply serves to illuminate the static printed display.

While such displays have a high degree of success and utility, as evidenced by many years of very successful use, the displays are generally quite specialized and limited to a specific type of use. Accordingly, many types of displays, such as lighted or dynamic displays, are not able to be used in many applications.

### SUMMARY OF THE INVENTION

The present invention recognizes that it would be beneficial to have a low-cost, internally powered lighted and/or dynamic display. In one embodiment, a display with light elements is provided. The display comprises a substrate layer and a display layer. The substrate layer comprises a power source, a plurality of light elements interconnected to the power source, and a controller interconnected to the power source and light elements. The substrate layer may be formed of flexible material. The controller is operable to activate at least a first light element to a different illumination state relative to at least a second light element. The display layer is interconnected to the substrate, covers at least a substantial portion of the substrate, said contains text and/or graphics covering at least a substantial portion thereof. The display layer may be formed of flexible material. At least one of the light sources is visible through the display layer when the light source is activated. The power source may include a solar cell and/or a battery. In embodiments in which the power source comprises both a battery and solar cell, the solar cell may be used to recharge the battery to operate the light elements and controller in low light conditions.

The controller, in some embodiments, is programmable to change at least one of a sequence and an intensity of activation of the light sources. In one embodiment, the substrate further comprises a switch operably interconnected with the controller, wherein the controller is preprogrammed with at least two lighting sequences selectable by actuating the switch in a predetermined sequence. In another embodiment, the substrate further comprises a programming port interconnected to the controller and adapted to be interconnected to an external programming device. In a further embodiment, the said substrate further comprises a receiver operably interconnected to the controller and operable to receive external signals and provide a programming sequence contained in the signals to the controller. The receiver, in an embodiment, comprises an antenna and an RF demodulator or an optical sensor.

The substrate, in still further embodiments, comprises one or more sensors. Such a sensor may be a motion detector operable to activate a sequence of light source activations when motion is detected. The sensor may also be a light detector operable to activate a sequence of light source activations when a low-light condition is detected. Other sensors, and combinations of such sensors may also be utilized.

### BRIEF DESCRIPTION OF THE DRAWINGS

FIG. 1 is a front perspective view of a display of an embodiment of the invention;

FIG. 2 is a block diagram illustration of a substrate and associated components for an embodiment of the invention;

FIG. 3 is a front plan view of a display and associated solar cell of an embodiment of the invention;

FIG. 4 is a block diagram illustration of a substrate and associated components for an embodiment of a display of FIG. 3;

FIG. 5 is a block diagram illustration of a substrate and associated components for another embodiment of a display of FIG. 3;

FIG. 6 is a front plan view of a display and associated key pad of an embodiment of the invention;

FIG. 7 is a block diagram illustration of a substrate and associated components for the embodiment of FIG. 6;

FIG. 8 is a front plan view of a display and associated sensor of an embodiment of the invention;

FIG. 9 is a block diagram illustration of a substrate and associated components for the embodiment of FIG. 8;

FIG. 10 is a block diagram illustration of a substrate and wireless transmit/receive unit of an embodiment of the invention;

FIG. 11 is a block diagram illustration of a substrate and associated audio component of an embodiment of the invention;

FIG. 12 is a front perspective illustration of a display and associated spacer layer of an embodiment of the invention;

FIG. 13 is a front plan view of a large format display of an embodiment of the invention;

FIG. 14 is a cross sectional illustration of a dual-sided display of an embodiment of the invention;

FIG. 15 is an illustration of a substrate of an embodiment of the invention;

FIG. 16 is an exploded view of a display of an embodiment of the invention;

FIG. 17 is a front plan view of a large format display of another embodiment of the invention; and

FIG. 18 is a front plan view of a multi-segment display of another embodiment of the invention.

### DETAILED DESCRIPTION

The present invention recognizes that it would be beneficial to have a lighted and/or dynamic display available for use in more applications than currently feasible to use such displays. Such lighted and/or dynamic displays provide enhanced visual appeal, making it more likely to be noticed by onlookers, and also provides additional visibility during low light or nighttime conditions. As mentioned above, lighted and/or dynamic displays are traditionally expensive and have limited placement options due to the requirement to have a power supply external to the display. Furthermore, such displays are traditionally relatively large and cumbersome, thus making them expensive to ship and install. The present invention recognizes that it would also be beneficial to have a relatively inexpensive display while still providing a lighted and dynamic display, which is able to be positioned in areas that are not limited by the requirement of available electricity. Furthermore, the present invention provides a display with light elements embedded therein to enhance the display visually. The display includes a surface layer that has text, graphics, and/or surface features that are viewable by an onlooker, and further provides light elements visible through the surface layer that are dynamic with light elements changing illumination states relative to other light elements. The display has a self-contained power supply, thus removing the requirement of the display being located in proximity to an electrical outlet, and in one embodiment the self-contained power supply includes a solar cell which acts to recharge a battery, thus providing a self contained renewable power supply. Furthermore, in another embodiment, the display is flexible providing for relatively easy mounting, shipping, and storage.

Such a display may be used in numerous different applications that have traditionally not been feasible for lighted/dynamic displays. For example, the display may be mounted to a vehicle, such as an automobile as an advertising sign, a bumper sticker, or a front license tag. The display may be secured to a window or other transparent material in a vehicle, building, or other structure, including windows at retail establishments. The display may be mounted to a support structure and used as a sign, such as, for example, a billboard, a real estate sign indicating the property is for sale, an open house sign, an open/closed sign, a no smoking sign, a warning sign (watch your step), to name but a few. A number of displays may be arranged in a strip and used for holiday lights during certain seasons or times of the year that are not required to be plugged into a power source. Furthermore, such a display may also find applications in gas stations, roadside signs providing public notices or information, novelties such as team pennants and paraphernalia, and directional signs such as detour signs or signs to a particular event. In some applications, the display may also include surface features that are raised from the plane of the display. Such surface features may include protrusions and/or depressions that correspond to graphics of the display, or the surface features may be Braille that corresponds to text contained in a display.

With reference now to FIG. 1, a top perspective view of a display of an embodiment of the invention is described. The display 20 includes text, graphics, and/or surface features 24 that are on an external surface of a display layer 28. The display layer 28 is mounted to a substrate 32. The text, graphics, and/or surface features 24 associated with the display 20 may be removably adhered to the display layer 28 in any conventional manner so the display 20 can function with multiple types of surface features. The substrate 32 contains light elements that are viewable through the display layer 28, as will be described in more detail below. The display 20 may take numerous different forms, including, for example, a relatively small display such as a bumper sticker for a vehicle, and relatively large displays such as posters and banners. The display layer 28, in an embodiment, includes translucent or transparent portions that are located in proximity to the light elements that are contained in the substrate 32. The light elements in the substrate 32 are thus visible through the translucent or transparent portions of display layer 28. While the light elements are described as visible through display layer 28 to provide some protection to the light elements and circuits, it would be possible for light elements to extend into display layer 28 or be visible through openings in display layer 28 (not specifically shown) rather than simply visible through the display layer 28. For example, the display layer 28 may have light sources integrated therein that are connected to the substrate 32. The light elements may be incorporated into the display layer using a silicon, applique, or other suitable technology, with conductive leads extending to corresponding contact areas of the substrate. Furthermore, in an embodiment, the substrate 32 includes a solar assembly and battery that provide a power source for the light elements and any associated control electronics. In this embodiment, the display layer 28 also includes a translucent or transparent area associated with the solar assembly. The display layer 28 may also include opaque portions.

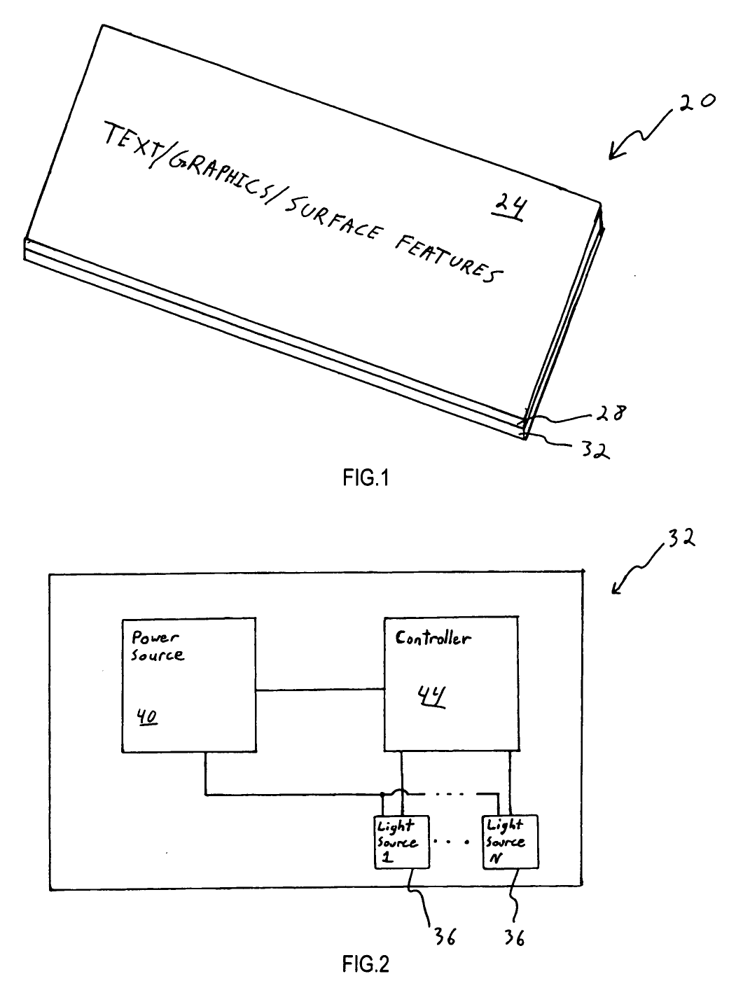

Referring now to FIG. 2, a block diagram schematic of one possible substrate 32 of an embodiment is described. In this embodiment, the substrate 32 includes a plurality of light sources 36, indicated in FIG. 2 as light source 1 through light source N. As will be understood, the number of light sources 36 may be any number desired for a particular application. The light sources 36 are interconnected to a power source 40 and to a controller 44. The power source 40 may be any suitable power source to power the controller 44 and the number of light sources 36 present for the particular application. Such a power source 40 may include, for example, a battery, a solar cell, a capacitor, or combinations thereof, to name but a few. In one embodiment, the power source 40 comprises re-chargeable battery and a solar cell. Another embodiment provides a power source 40 comprising an alkaline battery. The controller 44 is any suitable controller for such an application, and controls the activation and deactivation of the light sources 36. Furthermore, the controller 44 may control the brightness for a particular light source 36 and/or a particular color of light emitted by any one of the light sources 36. For example, one or more of the light sources 36 may include a bicolor LED, and the controller 44 may control the color of the light emitted by the LED. The light sources 36 may include any of a number of different light sources, including a light emitting diode, a laser diodes, fiber optic cable, incandescent lamps, appliqué radiation technology and organic light emitting devices, to name but a few. The controller may be any suitable microcontroller, or combination of logic gates, that operate to control light produced by the light sources 36 in the manner desired for a particular application. In one embodiment, the controller is a low-power 16 bit flash microcontroller with an operating range of about 2 volts to about 5.5 volts. However, it will be understood that any suitable controller may be used depending upon the particular application for the product. The substrate 32, in an embodiment is formed of a flexible material with the various components mounted thereon, forming a flexible circuit. The flexible material may be, for example, a rubber-type material of siliconized or synthetic rubber. Such a flexible circuit would be impenetrable to water also. However, the flexible substrate 32 may be formed of other suitable flexible type material, such as a flexible plastic. For example, the flexible substrate may be formed of an etched copper process or a silver ink screen-printed process embedded in a kapton or polyester base, urethane, or propylene.

As mentioned above, the power source 40 may include a solar cell and a rechargeable battery. In this manner, the battery may be recharged by the solar cell in order to provide power to the controller and light elements during periods when the solar cell is not generating power, such as during low light conditions. The rechargeable battery may be any suitable rechargeable battery or battery pack comprising two or more battery cells, including, for example, nickel-cadmium, lithium polymer, nickel-metal-hydride, and lithium ion batteries. The power source may also include, instead of or in addition to a battery, a capacitor that is capable of holding a relatively large charge that may be used to power the controller and light elements for an appropriate time period. For example, a supercapacitor may provide such power for a significant time period. Such a rechargeable power source provides a display that is capable of producing a dynamic lighted display for a significant period of time, provided that the solar cell is provided with enough light to recharge the battery. In other embodiments, the power source 40 includes an alkaline battery and no solar cell or other recharging component. Such a display will provide a dynamic lighted display for the time that it takes the charge in the alkaline battery to deplete to the point where it can no longer provide enough power to operate the controller and light elements. However, such a display will have a lower cost than a display having a solar cell and rechargeable battery. Such an alkaline battery powered display may be useful in many applications where the display is only desired to be operated for a limited time. For example, a marketing campaign may include advertising for a particular product for a limited time where it is desired to heavily promote the product. Such a campaign may include store displays that are to be set out only for a few weeks. Such a display may include a display as described herein that includes a power source with an alkaline battery. The battery may be selected to provide power for the display for the limited time period. For example, if Coca Cola desired to display 2 liter diet coke bottles for $0.99 for two weeks, the battery could be selected to provide sufficient energy that the display would be illuminated only the two weeks. Thereafter, the battery would have insufficient energy to illuminate the light sources. After which it is expected that the display will be discarded.

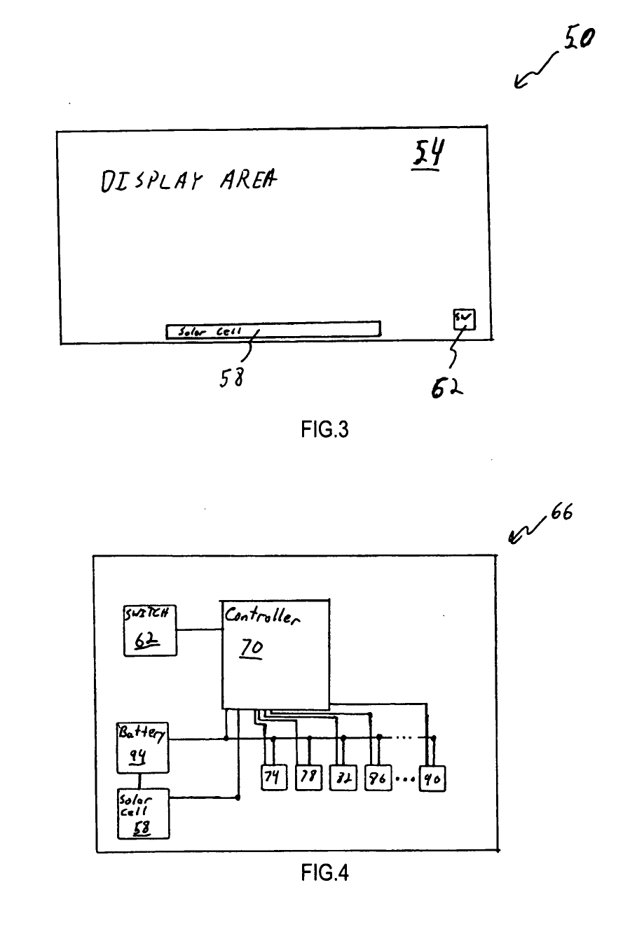

Referring now to FIG. 3, a display 50 of another embodiment is illustrated. In this embodiment, the display 50 has a display area 54 that is visible by a viewer. The display area 54, similarly as described above, includes transparent or translucent areas that allow light from various light elements on a substrate (not shown) to be visible through the display area 54. The display 50 also includes a solar cell 58 that is used to power the light elements and any associated electronic circuitry. Furthermore, in the embodiment of FIG. 3, the display 50 includes an optional switch 62 that may be used to power the display on and off. The solar cell 58 may be one of any number of suitable solar cells for such an application, and in one embodiment is an amorphous silicon solar cell that is flexible. The switch 62 is used to turn on and/or turn off the light elements and associated electronic circuitry thus helping to conserve power. For example, a user may only desire to activate the light elements associated with the display at night or during other low-light conditions. In such a case, the substrate may include a battery (not shown) that is used to operate the control electronics and light elements. The solar cell 58 recharges the battery during daylight hours, and the switch 62 may be used to turn off the display during daytime or high light conditions and used to turn on the display in low light or night conditions. The switch 62 may also simply be used to turn the display on, with the electronic circuitry within the substrate monitoring the status of the battery and reducing the frequency at which the light elements are activated and/or automatically powering off when the charge of the battery is at or below a preset threshold. In this manner, the battery may be recharged by the solar cell during daytime hours, and the display switched on using switch 62 for nighttime or limited use during low light conditions. In another embodiment, the electronic circuitry includes a timing device that causes the light elements to be activated for a preset time period following the actuation of the switch, or during preset hours such as between the hours of 8 p.m. and 7 a.m., for example. While FIG. 3 shows the solar cell 58 and the switch 62 visible through display area 54, one of ordinary skill in the art will now recognize that solar cell 58 and switch 62 may be exposed via the backside of substrate 32, not specifically shown as it is similar to the embodiment described above. In this manner, the display area 54 may be exposed to the inside of a store while the solar cell 58 is exposed to the light outside the store. The switch 62 may be displayed on the opposite side as the display area 54 as well.

Illustrated in FIG. 4 is a substrate 66 that is associated with the display 50 of FIG. 3. The substrate 66 includes a controller 70, a plurality of light sources 74 though 90 attached to the controller and to a battery 94 which is in turn connected to a solar cell 58. The switch 62 is also connected to controller 70. The solar cell 58 is connected to both the battery 94 and controller 70. In this embodiment, the controller 70 receives a voltage from the solar cell 58 at a pin associated with the solar cell, and activates voltage regulation circuitry associated with the battery 94 to control the recharging of the battery 94. The light sources 74-90 are connected to both the controller 70 and battery 94. The controller acts to activate a driver associated with one or more of the light sources 74-90 in order to change the state of a particular light source. The number of light sources 74-90 may be selected as required for a particular application of the display 50. The light sources 74-90 may be individually addressable and controlled by the controller 70, or may be controlled by the controller 70 in subsets or groups of light elements. If the light sources 74-90 are controlled as groups of light elements, each member of a particular group is controlled in a similar or same manner as other light elements within a particular group. For example, it may be desired that two or more of the light elements 74-90 are to be activated or otherwise changed in their state of illumination at simultaneous times. In this manner, the controller may control the activation of this group of light elements as a whole. In one embodiment, the display 50 and the substrate 66 include a plurality of columns of light elements. In this embodiment, each of the columns of light elements includes a plurality of light elements, each of which is activated simultaneously. In this manner, the columns of light elements are activated as a whole. The columns may be activated in a preset pattern such as a “running” pattern. Alternatively, the various rows of light elements may be actuated as a whole in order to create a visual effect of the different rows in the display area 54 being activated in unison. The order in which different light elements are lit may correspond to the text and/or graphics contained in the display area 54, or may be a random or other type of display pattern. Furthermore, light elements within a particular group may be connected in series with a delay circuit placed between two light elements, or the light elements may have circuitry integrated therein to turn on and off at a defined frequency.

Illustrated in FIG. 5 is a substrate 66a of another embodiment that is associated with the display 50 of FIG. 3. The substrate 66a includes a controller 70a that includes a timer 72, a plurality of light sources 74 though 90 attached to the controller and to a battery 94 which is in turn connected to a solar cell 58. The switch 62 is also connected to controller 70a. The substrate 66a operates in a similar fashion as described with respect to substrate 66 of FIG. 4, with some additional control available through the use of timer 72. In particular, the operation of the battery 94, solar cell 58, and light sources 74-90 may be done as discussed with respect to FIG. 4. In this embodiment, the timer 72 ma be set in a number of different manners to control the duration of the activation of the light sources 74-90. For example, the timer 72 may be set to a desired time period, such as four hours. When a user depresses or otherwise actuates switch 62, the controller 70a initiates the timer 72, and actuates the light sources 74-90 in any of the manners described above until the timer 72 indicates that the time period has expired. For example, in certain retail type applications, the display 50 may be used as a display where it is desired to have the light sources 74-90 active only during evening and night hours while the retail establishment is open for business. These hours may be from 6:00 p.m. until 10:00 p.m. In such a case, the timer 72 may be set at four hours, and a user may actuate the switch at around 6:00 p.m. thus turning the display on for four hours, until about 10:00 p.m. when the establishment closes. The timer 72 may also include a clock to automatically turn the display 50 on at a set time and turn the display off at a set time.

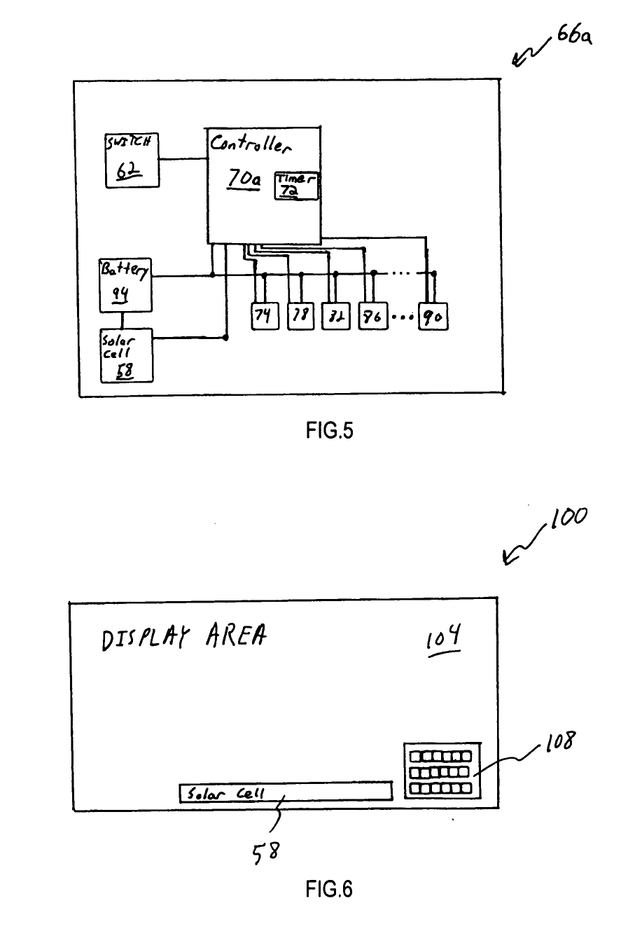

Referring now to FIG. 6, a display 100 of another embodiment of the invention is described. In this embodiment, the display 100 includes a display area 104 and a punch pad 108. The display also includes a solar cell 58 used in the power source for the display 100. As described above, the punch pad 108 and the solar cell 58 may be exposed on the back of display 100 instead of through display area 104. The punch pad, or key pad, 108 may be used to program different sequences in which the light elements contained in the display area may be lit, in order to generate varying different visual effects. Furthermore, the light elements may be arranged in a matrix display, thus allowing for text or other graphics to be displayed by the light elements when they are activated. The key pad 108 may be used to program the particular text and/or graphic or other sequence of lighting functions for the light elements in the display 100.

FIG. 7 is a block diagram illustration of a substrate 112 associated with display 100. The key pad 108 is connected to a controller 116 that is operable to receive programming information from the key pad 108. While shown integrated into the overall device, punch pad 108 may be a remote unit connectable to the controller 116 by a port, such as a serial bus port as a matter of design choice. The substrate 112 includes a power source 40 similar to the power source previously described, and a plurality of light sources 120, illustrated as light source 1 through light source N. Similarly as described above, the controller may be a 16-bit low-voltage flash microcontroller that is programmed to receive commands from key pad 108. The number of keys on key pad 108 may be any suitable number of keys, and may include keys for each letter of the alphabet, keys for each number, along with one or more special character keys. In other embodiments, in order to reduce the size of the key pad 108, fewer keys are present and, for example, may include relatively few keys that may be cycled through by pressing the key a predetermined amount of times to program the controller 116 to output a certain text or graphic character. The key pad 108 may also include various other devices, such as a track wheel. Alternatively, in another embodiment, the controller 116 is pre-programmed with a preset number of standard sequences in which the light sources 120 are activated. In this embodiment, the key pad may be used to select which of the sequences is to be displayed on the display 100. For example, the controller 116 may include pre-programmed lighting sequences. The key pad 108 may simply include a single key, or switch, that may be pressed by a user, and each time the controller receives an indication that the key has been pressed, the next pre-programmed lighting sequence is activated. The user may observe the display 100 and press the key until the desired sequence is observed. In one embodiment, the controller has several pre-programmed sequences, and also has one or more custom programmable sequences that may be entered by a user. As will be understood, numerous variations of pre-programmed and/or custom lighting sequences are possible.

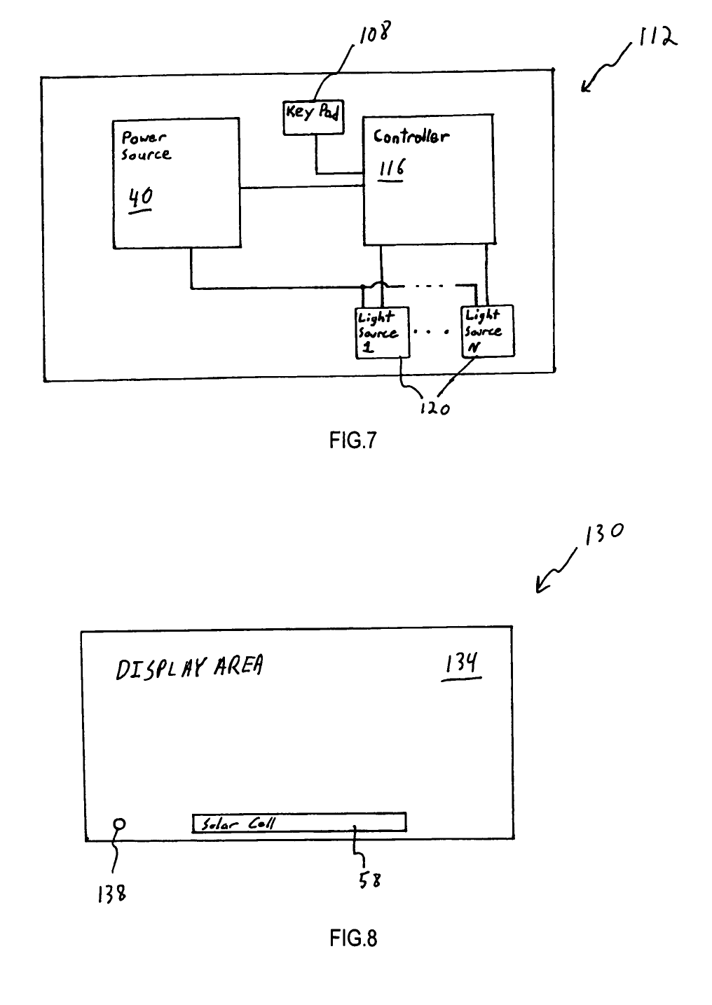

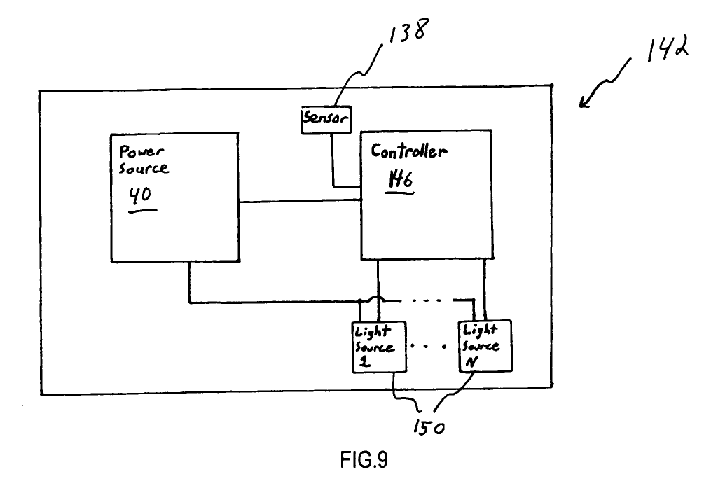

Referring now to FIG. 8, a display 130 of yet another embodiment of the invention is described. In this embodiment, the display 130 includes a display area 134 and a sensor 138 included within the display area. The display also includes a solar cell 58. FIG. 9 illustrates a block diagram illustration of the electronic components of a substrate 142 associated with display 130. The substrate includes a controller 146, and a plurality of light sources 150. The substrate 142 includes a power source 40. The sensor 138 may be, for example, a motion sensor, a light sensor, a heat sensor, and/or a sound sensor, such as a voice recognition sensor. A motion sensor may include a sensor that detects movement within a field of view of the sensor, or that can sense if the sensor itself is in motion. The sensor may trigger the controller to activate the light sources 150 upon certain input to the sensor 138. For example, if sensor 138 is a motion sensor that detects motion within its field of view, when the sensor detects such motion the controller 146 activates light sources 150. In this manner, the display only activates the light sources when motion is detected in the field of view of the sensor 138. In this manner, the power requirements of the display are reduced by only activating the display when motion is present and thus it is more likely that an onlooker would view the display. Similarly, the sensor 138 may be a light sensor, activating the controller 146 and light sources 150 only upon the detection of low light or night conditions. In this manner, the light sources 150 in the display 130 are only activated in low light conditions when the light sources more readily viewable. This may further provide reduced power consumption by the controller and light sources 150. As described above, the controller 146 may also include a timer. In such a case, the display will be active for only until the expiration of the preset time set in the timer. While the embodiments of FIGS. 1 through 9 illustrate various different functions, hardware, and features for the different displays, it will be understood that one or more of each of the items described may be included in a particular display. For example, a display may include one or more of a switch, a key pad and a sensor. Such variations will be readily understood by those of skill in the art.

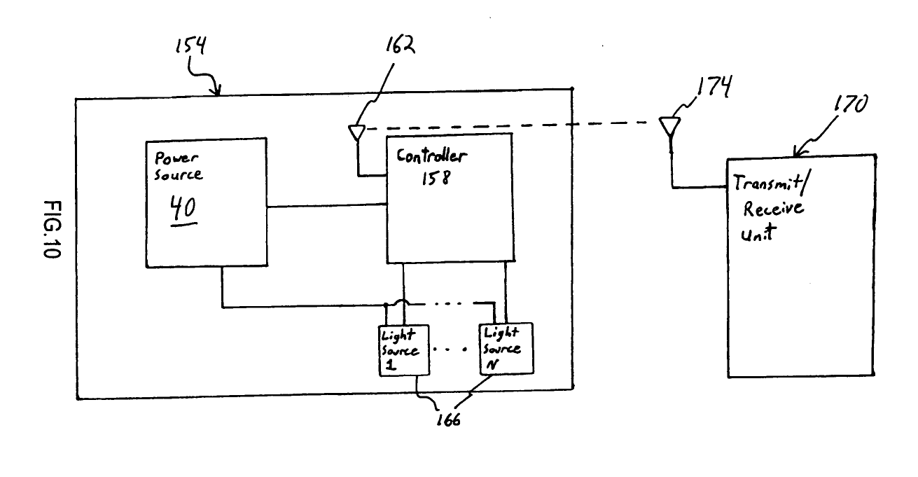

Referring now to FIG. 10, a substrate 154 of another embodiment is now described. In this embodiment, the substrate 154 includes a controller 158 that has an antenna 162 coupled thereto. The controller is coupled to a plurality of light sources 166, and controls the activation of the light sources 166. The substrate 154 further includes a power source 40 similarly as described above. The controller 158 and antenna 162 are used to receive programming commands for the display associated with the substrate 154 through a wireless connection. The controller, in this embodiment, includes necessary receiving circuitry to demodulate a signal received at the antenna 162 and obtain programming instructions from the signal that may then be used to program the controller to control the sequence of activation of the light sources 166. However, the substrate may contain such receiving circuitry separate from the controller. Referring again to FIG. 10, a transmit/receive unit 170 has an associated transmit/receive antenna 174 used to communicate with the substrate 154 and controller 158. The transmit/receive unit 170 may be any suitable unit to provide a signal to the substrate that contains programming instructions. The programming instructions contained in such a signal may simply direct the controller 158 to activate light sources 166 in a sequence, or to display information, that is preprogrammed into the controller 158. The programming instructions may also contain the sequence and/or information that is to be displayed. The signal provided by the transmit/receive unit 170 may be any type of wireless communications. For example, the communication may occur using a short-range wireless connectivity protocol, such as Bluetooth wireless technology. The communication may also occur using paging or wireless telephone technology. In one embodiment, a programmable radio frequency identification (RFID) integrated circuit is included in the substrate. Such RFID devices are well known and may be programmed remotely using well known RFID techniques. After the RFID tag is programmed, the controller may read the memory location of the RFID circuit and obtain programming instructions. While the display and substrate of this embodiment utilizes radio frequency communications to communicate programming instructions to the display, it will be understood that the substrate may also include an optical receiver that is connected to the controller and operable to receive an optical signal containing programming instructions.

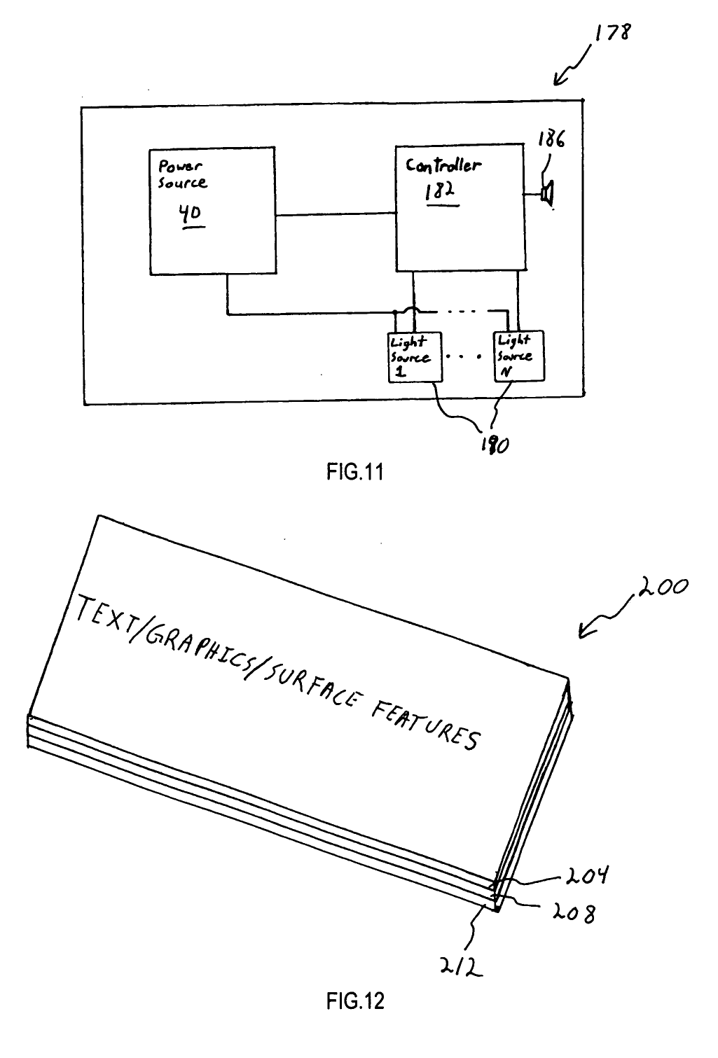

Referring now to FIG. 11, a substrate 178 of a further embodiment is illustrated. In this embodiment, the substrate 178 includes controller 182 that is operably interconnected to a speaker 186. The substrate 178 further includes light sources 190 and a power source 40 similarly as described above. The speaker 186, or any other sound emitting device, is coupled to the controller and the controller is programmed to activate the speaker 186 in order to produce a desired sound. Such a sound may correspond to a preset pattern associated with the activation of the light sources 190 and also may correspond to the text and/or graphics included on a display that is associated with substrate 178. For example, the display may include text and the controller 182 may operate the speaker 186 to provide an audio version of the text. Alternatively, the speaker 186 may be used to provide different types of audio, such as a sound effect that is likely to capture an onlooker's attention and draw their attention towards the display. In this manner, the number of people looking at the display may be further increased.

Referring now to FIG. 12, the display 200 of a further embodiment of the invention is illustrated. In this embodiment, the display 200 includes a display layer 204 that includes an external surface having text and/or graphics, a spacer layer 208, and a substrate 212. The spacer layer 208 is used to provide spacing between the display layer 204 and the substrate 212. This spacing results in a display layer 204 that is substantially planar, and also acts as a protection layer for the circuitry of the substrate 212. In the absence of such a spacer layer 208, the components of the substrate 212 may result in protrusions in the display layer 204, resulting in the display layer 204 having significant planar discontinuities. Having a spacer layer 208 can result in a substantially planar display layer 204 that is suitable to receive printing. When manufacturing the display, the display layer 204 may be a white layer, with translucent or transparent areas in appropriate locations for the associated light elements and solar cell (if present). The display 200 may then be subjected to a printing process such as a dye-sublimination or inkjet process directly to the display layer 204. Likewise, the printable surface could also be adapted to receive other printing processes, such as screen printing.

The spacer layer may be any suitable material depending upon the application of the display, and in an embodiment is a durable vinyl. However, the spacer layer may be formed of other types of material. For example, the spacer layer 208 may be a padding layer and the display 200 may be used on seat backs for chairs or benches, with the spacer layer providing padding for additional comfort to people sitting on the bench or chair. Alternatively, the spacer layer 208 may be a rubberized type material used to encapsulate the substrate 212 in order to provide waterproof layer. In this manner, the display 200 may be displayed outdoors during moist or rainy periods without the substrate being subject to moisture, which may adversely affect the components therein. Furthermore, the spacer material may be adapted to receive direct printing, or to otherwise receive the desired display text and/or graphics. In such an embodiment, the display layer 204 and spacer layer 208 may be integrated into a single layer. The light elements and associated control and power supply circuitry may also be included in a mold that could be printed upon. In this manner, the mold receives suitable paint or dyes, and the display material added to the mold and allowed to set, with the paint or dyes transferring from the mold surface to the material. The light elements and associated circuitry may be included in the molding process as well, thus resulting in a complete display.

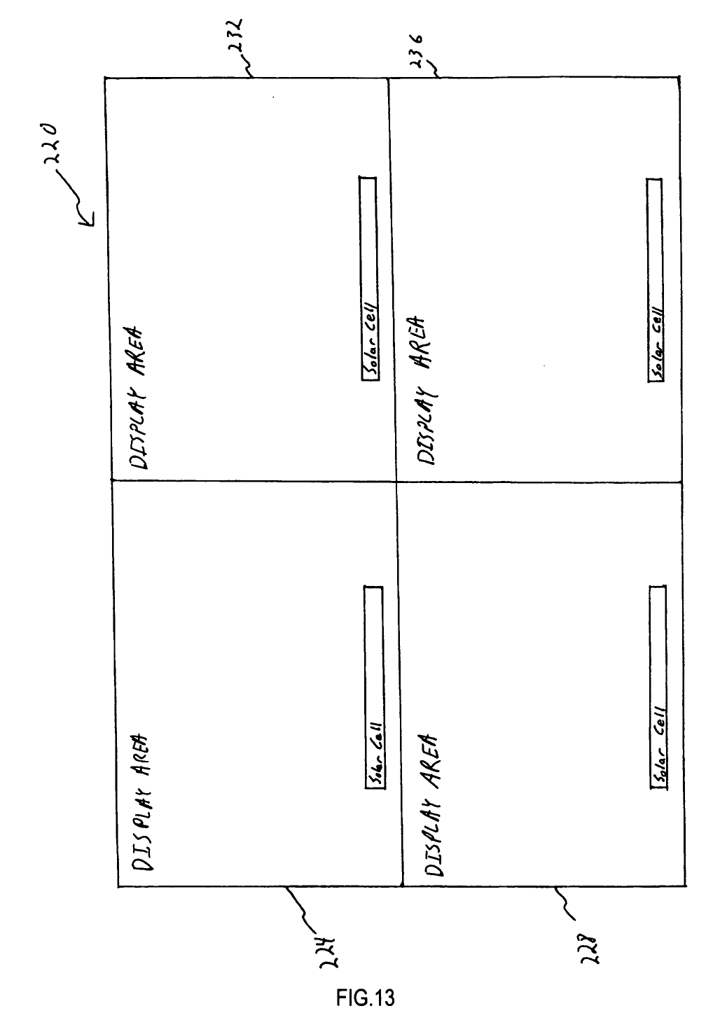

Referring now to FIG. 13, a large format display 220 of yet another embodiment is described. In this embodiment, the large format display includes a plurality of different display areas 224, 228, 232, 236. Each of the display areas 224 through 226 includes a separate power source including a solar cell. Thus, each display area in this embodiment is an independent display. The displays may be programmed to provide complimentary visual effects through light elements contained in each of the display areas thus providing a relatively large format display that has the appropriate power supplies that are associated with each of the display areas. Alternatively, the large area display 220 is made of a material that may be cut along the boundaries of each of the display areas, thus providing four separate displays.

Each display area 224-236 of the display 220 is designed to be self-contained, with an adequate space provided between circuitry and/or wiring for each area to allow for cutting of the display areas 224-236 with reduced likelihood that circuitry of a particular area will be compromised in the cutting process. In this manner, the displays may be manufactured in a batch type process to provide a display that a user may select to be a particular size. For example, if a user were to desire a large area display, the user would purchase a large area display 220 and use one or more of the display areas 224-236 to provide the desired visual display. Similarly as described above, one or more of the display areas 234-236 may be programmed, or be programmable, to display different lighting sequences. A user may then select, or program, the particular display area(s) 224-236 to provide the desired visual display for the large area display. The large format display 220 may be mass-produced in sheet sizes that conform to typical sheet sized used for printing processes, such as 16 inches by 20 inches. Such a sheet may be printed as a single display, or be printed in a four-up fashion per sheet and then cut into smaller pieces such as four 8 inch by 10 inch sheets. As mentioned above, the number of independent display areas per sheet may be smaller or larger than four.

In one embodiment, the controllers in each of the separate display areas 224-236 may be synchronized to provide a desired visual display. In such a case, the controllers may include leads that extend between the display areas 224-236 and provide synchronization and/or other communications between controllers. These leads, if severed, result in the controller operating independently of any other controllers, and thus allow for the large area display to be separated into two or more independent displays. As in the example above, a user may desire to have four separate but smaller displays. The user may then cut the large area display 220 along the boundaries of each of the display areas in order to provide the four separate displays. In this embodiment, essential circuitry and leads associated with each of the display areas in the substrate is located at a safe distance from the display area boundary to provide for slight errors while cutting the large area display 220 into separate displays. As will be understood, the number of different display areas included in a particular large area display 220 may be selected to be a larger or smaller number than the number illustrated in FIG. 13. For example, a large area display 220 may include 8, 10, 12, or more individual display areas and be capable of being cut to a desired size.

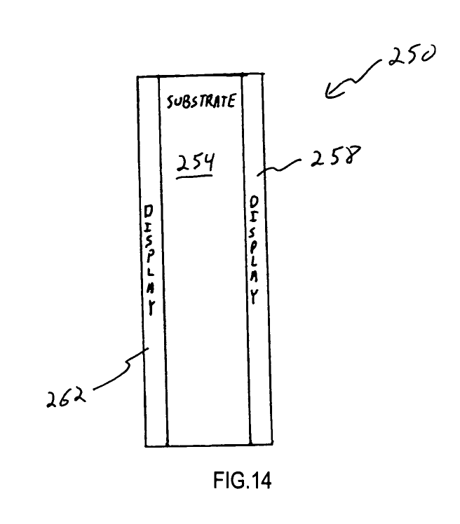

Referring now to FIG. 14, yet another embodiment of the invention is illustrated. In this embodiment, a display 250 is a dual sided display. The display 250 includes a substrate 254 and associated circuitry and light elements (not shown). The substrate 254 may include any or all of the components described above with respect to substrates of previously described embodiments. A first display layer 258 and a second display layer 262 are present on opposite sides of the substrate 254. In this manner, the display 250 may provide both visual and lighted displays on both sides of the substrate 254. Such an embodiment may be useful in a number of situations in which both sides of the display 250 are desired to be viewed. For example, a retail store window may include the display 250, thus providing a view of the display from onlookers both inside and outside of the establishment. Similarly, displays may be made having more than two surfaces with display layers, such as a box. Additionally, the display could be cylindrical in shape. The principles described herein would be equally applicable to such displays. Furthermore, a display area may include a curved surface as well.

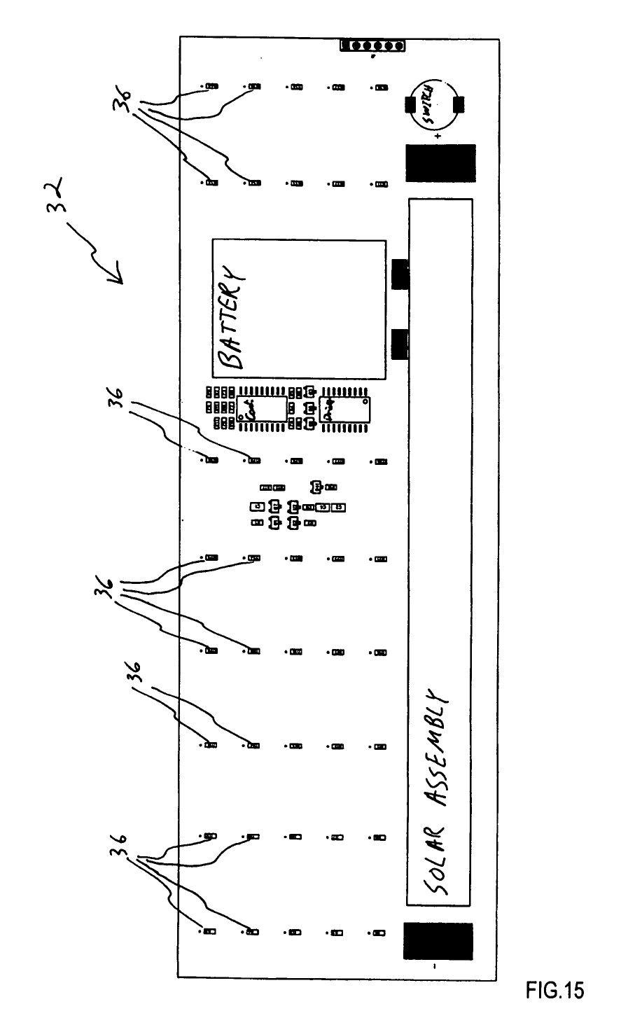

Referring now to FIG. 15, a substrate 300 of still a further embodiment of the invention is illustrated. In this embodiment, a plurality of light elements 304 are arranged in 8 separate columns, each column containing 5 light elements 304. The substrate 300 includes a power supply that comprises a battery 308 and a solar assembly 312. The solar assembly 312 may be used to power the light elements 304 directly, and also may be used to recharge battery 308. Alternatively, the battery 308 may be used to supply power to the light elements 304 and then be recharged using the solar assembly 312. The substrate 300 includes a controller 316 and a driver 320. The controller 316 receives power from the power supply and is programmed to activate one or more of the light sources 304 through the driver 320. The substrate includes a switch 324 to turn on and off the light assembly. The substrate further includes a data port 328 that may be used for programming the controller 316 to operate and actuate the light elements 304 in a desired sequence or pattern. For example, if the punch pad 108 was remote, it may plug into data port 328 to program controller 316.

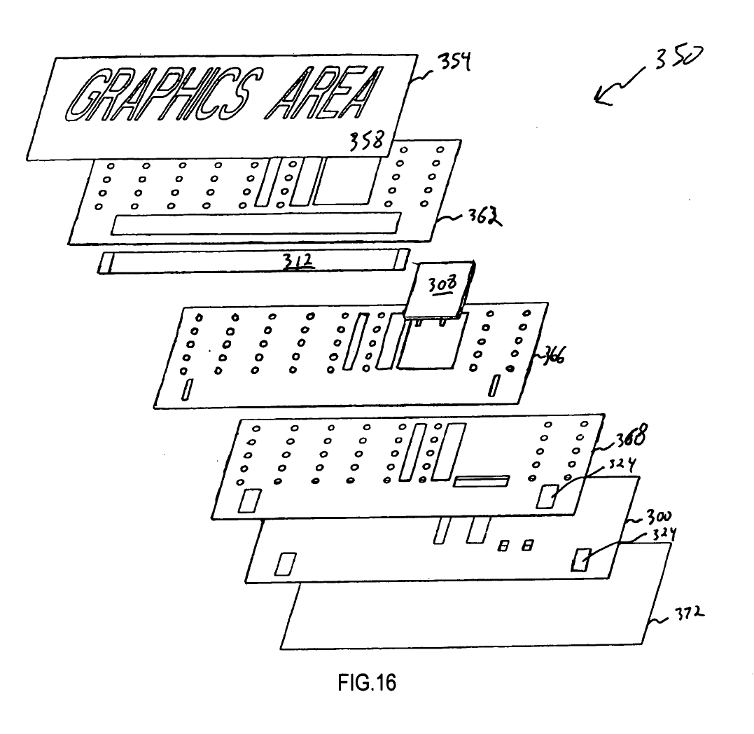

Referring now to FIG. 16, a blown up perspective view of a display 350 incorporating the substrate 300 illustrated in FIG. 15 is described. The display 350 includes a graphics layer 354 that may include text and/or graphics in a graphics area 358. An adhesive layer 362 is used to secure the display layer 354 to a first spacer layer 366. The first spacer 366 is used to provide an adequate amount of space between the substrate layer 300 and the display layer 354 so as to provide a space in which the battery 308, solar cell 312, and any other components, may be included in the display 350 without resulting in any protrusions from the plane of the display layer 354. A second adhesive layer 368 couples the spacer layer 366 to the substrate 300. Finally, a mounting layer 372 is included on the other side of the substrate 300 and is used to secure the display to a surface or other mounting device that is to be used to support the display 350. The mounting layer 372 may include any suitable material that may be used to mount the display 350 for a particular application. Such material may include, for example, an adhesive, magnetic material, corresponding hook and loop material, and static cling material, to name but a few. The particular material selected for the mounting layer 372 may be based on the application the display 350 is to be used in. For example, an adhesive may be selected when it is desired to permanently mount the display 350 to the mounting surface, while a magnetic material may be used to secure the display 350 to a steel surface of a vehicle and allow for relatively east removal of the display. In one embodiment, the mounting layer is a static cling layer that may be used to secure the display to a glass surface. In other embodiments, the mounting layer is included on the display layer, providing a display that may be mounted on an interior side of a glass surface with the display viewable from an exterior side of the glass. In still further embodiments, the mounting layer includes hardware that is adapted to engage a mounting surface or complimentary hardware on the mounting surface, such as suction cups, slots that engage with pins in a mounting surface, rails, pins that may be inserted into a bulletin board or other surface, and hook and loop material, to name but a few.

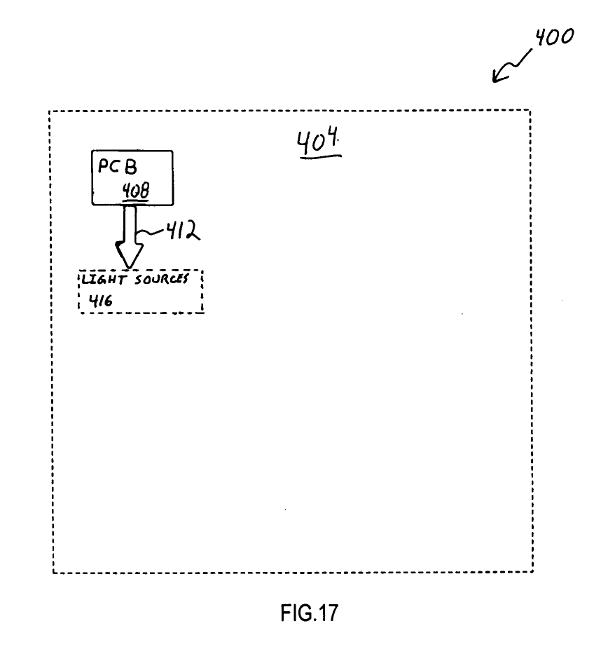

Referring now to FIG. 17, a further embodiment of the invention is illustrated. In this embodiment, a display 400 is a relatively large-sized display. The display 400 has a display area 404 that is similar to the display areas previously described. As mentioned, the display area 404 of this embodiment is relatively large, such as poster size, billboard size, or even larger. In such an application, having a printed circuit board (PCB) containing light sources that is the entire size of the substrate area may not be cost effective. In the embodiment of FIG. 17, the display 400 includes a PCB 408 that is significantly smaller than the size of the entire display area 404. The PCB 408 includes all of the electronic circuitry as described above that is associated with the substrate, with the exception of some, if not all, of the light sources. In this embodiment, the PCB 408 connects to a plurality of conductors 412, which in turn to individual light sources illustrated as 416 in this drawing figure. As will be understood, the light sources may be placed throughout the display area 404, and are illustrated as a single entity 416 simply for the purposes of discussion and illustration. The conducting elements 412 may be formed of any appropriate conductive material, such as silver ink traces, ribbon cables, and wire, among others. The conducting elements 412 may be relatively inflexible, such as an embodiment where the display 400 is a relatively hard poster or billboard. The conducting elements 412 may also be flexible, allowing the display to be rolled or placed on a non-planar surface. The PCB 408, as mentioned above, may include a self-contained power source that is capable of recharging and has an associated solar panel similarly as described above.

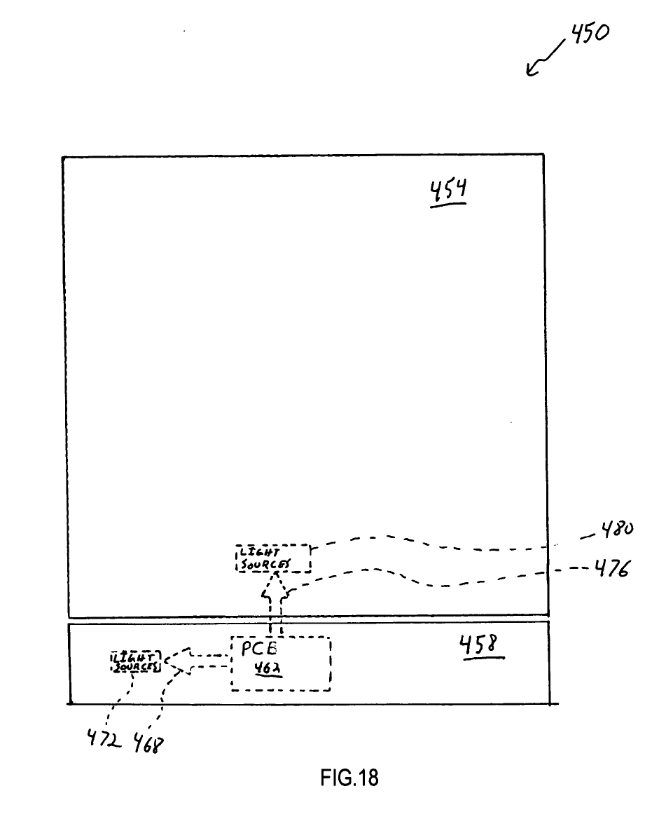

Referring now to FIG. 18, a multi-component display 450 of a further embodiment of the invention is described. In this embodiment, the multi-component display 450 includes a relatively large and modular display portion 454 and a relatively small fixed display portion 458. In this embodiment, the fixed display portion 458 includes all of the electronic control circuitry, illustrated as PCB 462, for actuating the various light sources in both the fixed and modular display portions 458, 454. The PCB 462 is connected to a plurality conductive elements 468 that are coupled to a plurality of light sources 472 within the fixed display portion 458. As will be understood, the light sources 472 may be arranged uniformly, or in predefined patterns, throughout the area of the fixed display 458. In this embodiment, the modular display portion 454 includes a plurality of light sources 480 that are connected to the PCB 462 of the fixed display portion 458 by conductive elements 476. The connection between the PCB 462 and light sources 480 may be through any connection that allows the modular display portion 454 to be removed and replaced as desired. In one embodiment, the fixed portion 458 includes a male electrical connector with a plurality of pins corresponding to a female connector associated with the modular display portion 454. In this embodiment, each of the pins corresponds to one or more of the light sources 480, electrically connecting the light sources 480 to the PCB 462. Similarly as described above, the light sources 480 may be spaced throughout the modular display portion 454 in a uniform pattern, or in a non-uniform pattern that corresponds with elements of the display. In this manner, the fixed display portion 458 may be coupled to any of a number of different modular display portions 454 throughout a period of time.

Such a display 450 may be useful in numerous types of applications, such as, for example, in a retail establishment where a particular product is desired to be advertised. A modular display 454 may be coupled with the fixed portion 458 that has a display area directed to a first product such as a cola product. At the end of the promotion for the cola product, it may be desired that a promotion be run on a snack product. A separate modular display 454 having a display area graphic directed towards the snack product may then be connected to the fixed portion 458. The PCB 462 may be reprogrammed to change the sequence of lighting the light sources 472 and/or the light sources 480 depending upon the desired promotion. In one embodiment, the fixed display portion 458 is a scrolling type display that may include text and/or graphics for a particular product. For example, text may scroll through the display area 458 that describes the product that is being promoted along with a price for that product. The modular display area 454 may include a graphic illustration of the product with light sources at various areas throughout the display to accent and/or highlight the product and also to draw additional attention to the display 450. When it is desired to change the product being promoted, the controller or microprocessor within the PCB 462 may be reprogrammed as appropriate for the next promotion. Alternatively, in an embodiment, the modular portion 454 includes a substrate containing light sources that are spaced uniformly throughout and is adapted to receive a display layer that is fixed to the substrate and may later be removed. In such a manner, the display 450 may be used in different promotions by merely changing the display layer associated with the modular display portion 454, and reprogramming the PCB 462 to activate the light sources 472, 480 in a desired pattern. Similarly as described above, the display areas may have displays on two or more surfaces rather than just a single surface, and the display areas may also be non-planar in shape.

While the invention has been particularly shown and described with reference to various embodiments thereof, it will be readily understood by those skilled in the art that various other changes in the form and details may be made without departing from the spirit and scope of the invention.

1. A display with light elements, comprising:
a substrate layer, comprising:
a self-contained power source;
a plurality of light elements;
a controller operably interconnected to said power source and said light elements, and operable to activate at least a first light element to a different illumination state relative to at least a second light element; and
a display layer interconnected to said substrate and covering at least a substantial portion of a first side of said substrate, said display layer comprising text and/or graphics covering at least a substantial portion thereof, wherein at least one of said light sources are visible through said display layer when said light source is activated.

2. The display, as claimed in claim 1, wherein said power source comprises a solar cell.

3. The display, as claimed in claim 1, wherein said power source comprises a battery and a solar cell, wherein said solar cell is operable to recharge said battery.

4. The display, as claimed in claim 1, further comprising:
a mounting layer operably interconnected to a second side of said substrate, said second side opposite said first side, wherein said mounting layer is operable to secure said display to a structure.

5. The display, as claimed in claim 4, wherein said mounting layer comprises at least one of an adhesive, a hook and loop material, and a magnet.

6. The display, as claimed in claim 1, further comprising:
a mounting layer operably interconnected to said display layer and operable to secure said display to a structure.

7. The display, as claimed in claim 1, wherein said light sources comprise light emitting diodes.

8. The display, as claimed in claim 1, wherein said controller is programmable to change at least one of a sequence and an intensity of activation of said light sources.

9. The display, as claimed in claim 8, wherein said substrate further comprises a switch operably interconnected with said controller, wherein said controller is preprogrammed with at least two lighting sequences, said sequences selectable by actuating said switch in a predetermined sequence.

10. The display, as claimed in claim 8, wherein said substrate further comprises a programming port adapted to be interconnected to an external programming device.

11. The display, as claimed in claim 8, wherein said substrate further comprises:
a receiver operably interconnected to said controller, said receiver operable to receive signals and provide a programming signal contained in the signals to said controller.

12. The display, as claimed in claim 11, wherein said receiver comprises an antenna and an RF demodulator.

13. The display, as claimed in claim 11, wherein said receiver comprises an optical sensor.

14. The display, as claimed in claim 1, wherein said substrate further comprises a motion detector operable to activate a sequence of light source activations when motion is detected.

15. The display, as claimed in claim 1, wherein said substrate further comprises a voice recognition sensor operable to activate a sequence of light source activations when sound is detected.

16. The display, as claimed in claim 1, wherein said substrate further comprises a timer operable to deactivate said controller upon the expiration of a predetermined time period following activation of said controller and light sources.

17. The display, as claimed in claim 1, wherein the display is a bumper sticker for an automobile.

18. The display, as claimed in claim 1, wherein the display is a poster mounted on a wall and/or visible through a window.

19. A flexible lighted display, comprising:
a flexible substrate layer, comprising:
a power source;
a plurality of light elements;
a controller operably interconnected to said power source and said light elements, and operable to activate at least a first light element to a different illumination state relative to at least a second light element; and
a display layer interconnected to said substrate and covering at least a substantial portion of a first side of said substrate, said display layer comprising text and/or graphics covering at least a substantial portion thereof, wherein at least one of said light sources are visible through said display layer when said light source is activated.

20. The display, as claimed in claim 19, wherein said power source comprises a battery and a solar cell and a battery, wherein said solar cell is operable to recharge said battery.

21. The display, as claimed in claim 19, wherein said controller is programmable to change at least one of a sequence and an intensity of activation of said light sources.

22. The display, as claimed in claim 19, wherein said substrate further comprises a detector operable to activate a sequence of light source activations when a predetermined condition external to the display is detected.

23. A flexible lighted display, comprising:
a flexible substrate layer, comprising:
a power source; and
a controller operably interconnected to said power source;
a display layer interconnected to said substrate and covering at least a substantial portion of a first side of said substrate, said display layer comprising text and/or graphics covering at least a substantial portion thereof, and
a plurality of light elements;
wherein said power source and said controller are operably coupled to said plurality of lights to activate at least a first light element to a different illumination state relative to at least a second light element such that at least one of said light sources are visible on said display layer when said light source is activated.

24. The display, as claimed in claim 23, wherein at least one of the plurality of light elements is in the display layer.

25. The display, as claimed in claim 23, wherein at least one of the plurality of light elements is in the flexible substrate layer.

26. The display, as claimed in claim 23, wherein the controller includes a timer that causes the plurality of lights to deactivate after a predetermined period of time.

27. The display, as claimed in claim 23, further comprising a sensor that operates to activate the plurality of lights, the sensor selected from a group of sensors consisting of: a light sensor, a motion sensor, a heat sensor, or a sound sensor.

28. The display, as claimed in claim 23, wherein the controller selectively alters the activation of the plurality of light elements when the battery charge falls below a predetermined threshold.

29. A flexible lighted display, comprising:
a flexible substrate layer, comprising:
a power source; and
a controller operably interconnected to said power source; and
a plurality of light elements operatably connected to the power source and the controller and the controller causes the lights to illuminate; wherein
the power source includes a solar cell.

30. The display, as claimed in claim 29, further comprising:
a display layer interconnected to said flexible substrate and covering at least a substantial portion of a first side of said substrate, said display layer comprising text and/or graphics covering at least a substantial portion thereof.

31. The display, as claimed in claim 29, wherein the power source further comprises a battery.

32. The display, as claimed in claim 31, wherein the battery is a rechargeable battery and the solar cell is operably connected to the rechargeable battery to recharge the battery.
